(19) United States
(12) Patent Application Publication
(10) Pub. No.: US 2026/0170431 A1
(43) Pub. Date: Jun. 18, 2026

(54) SYSTEMS AND METHODS FOR A COLLABORATIVE MULTIPLE ARTIFICIAL INTELLIGENCE AGENT ARCHITECTURE

(71) Applicant: Salesforce, Inc., San Francisco, CA (US)

(72) Inventors: Weiran Yao, Palo Alto, CA (US); Zhiwei Liu, Austin, TX (US); Zuxin Liu, Palo Alto, CA (US); Juntao Tan, Palo Alto, CA (US); Jianguo Zhang, San Jose, CA (US); Frank Wang, San Francisco, CA (US); Huan Wang, Palo Alto, CA (US); Shelby Heinecke, San Francisco, CA (US); Silvio Savarese, Palo Alto, CA (US); Caiming Xiong, Menlo Park, CA (US)

(21) Appl. No.: 19/255,996

(22) Filed: Jun. 30, 2025

Related U.S. Application Data
(60) Provisional application No. 63/735,248, filed on Dec. 17, 2024.

(51) Int. Cl. G06Q 10/0631; H04L 51/02

(52) U.S. Cl. CPC G06Q 10/06316; H04L 51/02

(57) ABSTRACT

Embodiments described herein provide a multi-agent collaborative environment for different types of agent within a multi-agent library. For example, multiple AI agents may be integrated with visual components for a variety of applications. Example AI agents may include a collaborative specialist team for enhancing business workflows and foster decision making from diverse perspectives, a proactive support specialist with in-depth knowledge of specific conversation channels (e.g., a scrum team channel) to assist every team member proactively, and a personal assistant agent that is deeply familiar with individual users, offering tailored support and solving private tasks efficiently.

### CROSS REFERENCE(S)

The application is a nonprovisional of and claims priority to co-pending and commonly-owned U.S. provisional application No. 63/735,248, filed Dec. 17, 2024.

This application is related to co-pending U.S. nonprovisional application No. _______ (attorney docket no. 70689.401US02), filed on the same day.

The aforementioned applications are hereby incorporated by reference herein in their entirety.

### TECHNICAL FIELD

The embodiments relate generally to machine learning systems for artificial intelligence (AI) agents, and more specifically to systems and methods for a collaborative multiple artificial intelligence (AI) agent architecture.

### BACKGROUND

AI agents are autonomous software entities designed to perform specific tasks, make decisions, and interact with both humans and other AI agents. AI agents can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

Existing AI agent is typically trained on specific domain knowledge and/or tasks, and then deployed on a particular platform. As the use of AI agents, the current AI agent framework lacks scalability to support the growing demands of agentic implementations, especially multi-agent collaboration.

### BRIEF DESCRIPTION OF THE DRAWINGS

FIG. 1A shows an example operation of an LLM based AI agent integrated into a messaging platform, according to embodiments of the present disclosure.

FIG. 1B is a simplified diagram illustrating examples of AI agents shown in FIG. 1A within an organization architecture, according to some embodiments.

FIG. 2 is a simplified diagram illustrating an example multi-agent collaborative environment, according to some embodiments.

FIG. 3 is a simplified diagram illustrating an example implementation of collaborative agent actions, according to some embodiments.

FIG. 4A is a simplified diagram illustrating a computing device implementing the framework described in FIGS. 1-3, according to one embodiment described herein.

FIG. 4B provides an example architecture of the AI module described in FIG. 4A, according to embodiments described herein.

FIG. 5 is a simplified diagram illustrating the neural network structure implementing the AI agent module described in FIG. 4A, according to some embodiments.

FIG. 6 is a simplified block diagram of a networked system suitable for implementing the AI conversation framework described in FIGS. 1-5 and other embodiments described herein.

FIG. 7A provides an example logic flow diagram illustrating a method of operating a collaborative multi-agent system at a messaging platform based on the framework shown in FIGS. 1-6, according to some embodiments described herein.

FIG. 7B provides an example logic flow diagram illustrating a method of building collaborative multi-agent system at a messaging platform based on the framework shown in FIGS. 1-6, according to some embodiments described herein.

FIGS. 8A and 8B provide simplified diagrams illustrating an example application of an autonomous customer service agent team on the messaging platform, according to embodiments described herein.

FIG. 9 is a simplified diagram illustrating an example application of a periodic check-in agent on the messaging platform, according to embodiments described herein.

FIG. 10 is a simplified diagram illustrating an example application of a verification agent on the messaging platform, according to embodiments described herein.

FIG. 11 is a simplified diagram illustrating an example application of a channel assistant agent on the messaging platform, according to embodiments described herein.

FIG. 12 is a simplified diagram illustrating a command-in-line (CLI) user interface for the multi-agent framework, according to embodiments described herein.

FIGS. 13A-13B provide simplified diagram illustrating a dashboard interface for the multi-agent framework, according to embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

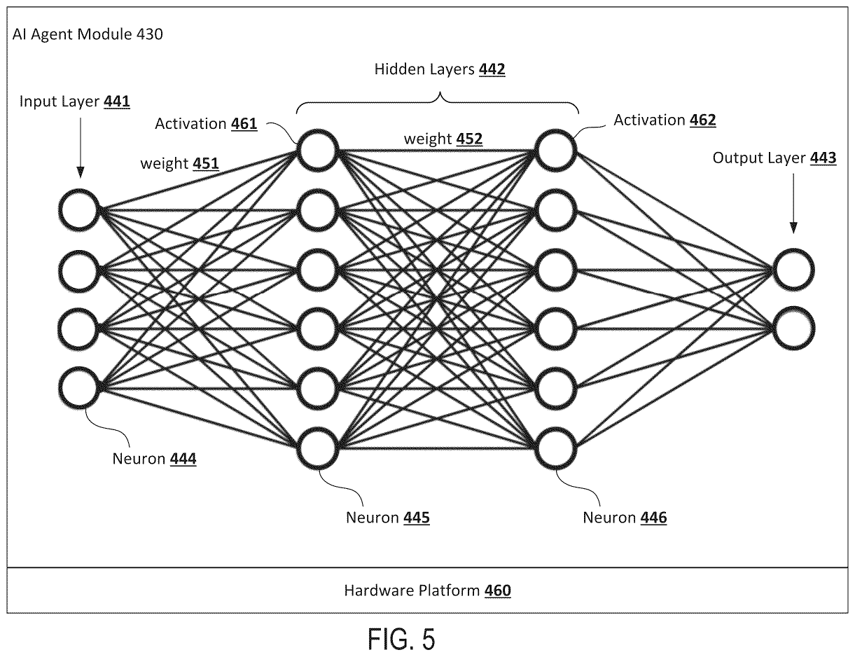

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 5.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Existing AI agent is typically trained on specific domain knowledge and/or tasks, and then deployed on a particular platform. As the use of AI agents, the current AI agent framework lacks scalability to support the growing demands of agentic implementations, especially multi-agent collaboration. Additionally, while many AI models (such as LLMs) may perform well in controlled or simulated settings, they often fail to translate seamlessly into practical daily workflows in a real-world work environment, such as an organizational workspace. This gap emphasizes the need for a specialized framework or library designed specifically for workplace deployment. AI agents may thus be built from the ground up with real-world tasks and be immediately adaptable in professional settings and to be continuously improved through regular, collaborative use.

In view of the need for efficient AI agent management and operation, embodiments described herein provide a multi-agent architecture integrated with a messaging platform to customarily build a set of AI agents that collaboratively automate workflows. The architecture includes a collaboration module that facilitates inter-agent communication, standardized collaboration protocols, and session management for context persistence. Developers can configure AI agents with defined personas, tools, and behaviors using a builder submodule. Agents are connected via message handlers and organized into workflow graphs that represent task execution sequences. A workflow abstraction encapsulates these graphs into scalable processes triggered within messaging channels. Agent tools are defined via functions, Pydantic models, or OpenAPI specifications, enabling seamless interaction with external systems and automation of complex, multi-step tasks.

The built multi-agent system may store a multi-agent library pre-defined with different types of AI agents separately fine-tuned on different domain or task data. Given a task description, AI agents may autonomously determine when to involve other AI agents from the library to complement the multi-agent structure, enabling a distributed decision-making process. For example, upon detecting a user message on the messaging platform, an AI agent may send a request to the library to involve another AI agent to respond to the user message. In this way, the multi-agent system may directly operate along multiple conversation sessions on the messaging platform to monitor the dialogues and calling for a particular AI agent to inject responses based on the monitored conversation context.

In this way, users (such as enterprise users) may build their own AI agents on a messaging platform within their enterprise network, without training LLMs on sensitive workspace data. The multi-agent system may be customized and/or adapted into a workspace operating team to automate task flows without human intervention. In this way, enterprise data privacy and network security can be protected within the domain. AI technology in workspace automation is improved.

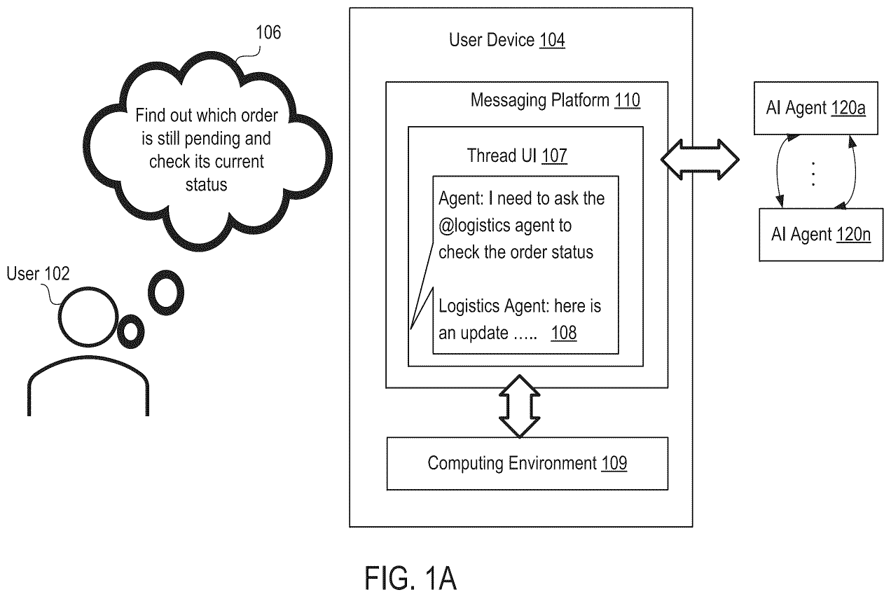

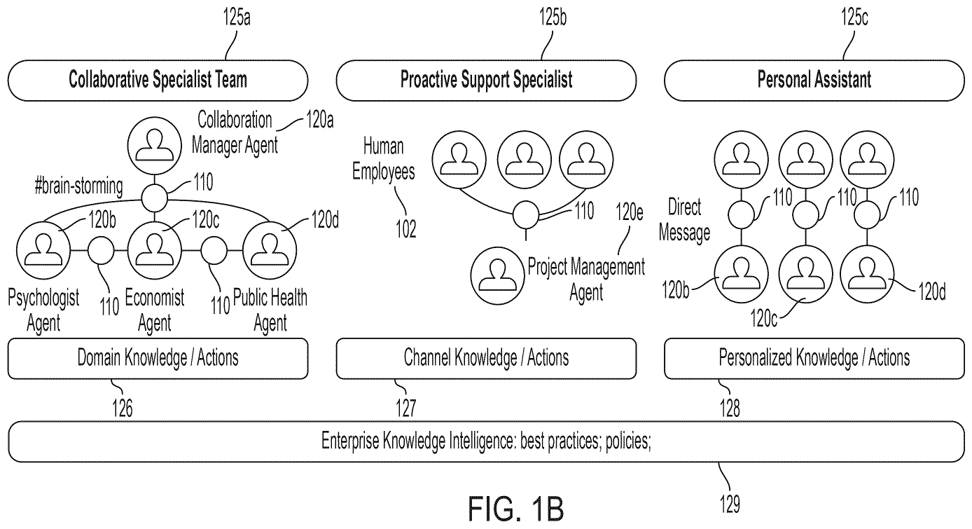

FIG. 1A shows an example operation of an LLM based AI agent integrated into a messaging platform, according to embodiments of the present disclosure. One or more LLM-based AI agents 120a-n may be implemented by integrating into a messaging platform 110 on a user device 104 interacting with the computing environment 109 to receive a user task request 106 as a natural language input, typically through a chat or command interface 107. The LLM based AI agents 120a-n may be hosted at an external server, a cloud service, and/or the like that is accessible by a communication network. In a different implementation, the LLM-based AI agents 120a-n may be hosted on the user device 104. An input to the AI agents 120a-n may comprise the task request 10, which may in turn be sent to one of the AI agents 120a-n upended with an instruction to guide the generative behavior of the corresponding AI agent or responses in a particular way, referred to as a “system prompt.”

It is to be noted that the AI agents 120a-n are shown in FIG. 1 for illustrative purpose only. In some embodiments, the AI agents 120a-n may be implemented by one LLM, or multiple LLM(s) deployed on different hardware platforms, such as distributed servers, may be communicatively coupled to support the AI agents 120a-n.

In one embodiment, the LLM(S) supporting the AI agents 120a-n may comprise one or more smaller LLMs, or may be guided by different system prompts to in turn generate a response 108 to the task request 106. Additional details on the LLM generating output tokens to form the response 108 may be described in FIG. 5.

In some embodiments, the AI agents 120a-n may be integrated onto a messaging platform 110 as a virtual conversational entity. For example, at least one AI agent may generate a response 108 via the UI 107 of the messaging platform 110. In one embodiment, at least one AI agent may reference and invoke another AI agent, depending on the task request 106, such that the invoked AI agent may generate a response via the thread UI 107.

In one embodiment, the invoked AI agent may generate a text response 108 displayed via the thread UI 107. Additionally, the invoked AI agent may generate a code script such as a system-level command to invoke an application running on the computing environment 109 to perform an action, e.g., to trigger an email application to compose and send an email, to trigger a calendar application to add a calendar event, and/or the like. These actions may be performed by invoking one or more specialized AI agents for operating with the specialized applications or computing environment 109.

Therefore, the multi-agent framework including AI agents 120a-n may be integrated within workplace communication platforms 110. This agentic layer integrates into an organizational workflows, providing instant deployment and continuous refinement of AI agents through everyday interactions.

FIG. 1B is a simplified diagram illustrating examples of AI agents 120a-n shown in FIG. 1A within an organization architecture, according to some embodiments. In one embodiment, different types of AI agents 125a-c (similar AI agents 120a-n) may be retrieved and/or invoked from a multi-agent library. For example, the multi-agent library may store three types of AI agents 125a-c each designed, trained and/or finetuned for a distinct role in multi-turn conversations.

In one embodiment, an assistant agent 125a may be configured to use various tools such as custom functions, public APIs, external libraries, and code interpreters to assist users through ongoing conversations. For example, an assistant agent 125c may be finetuned on personalized knowledge and/or action data 128. Each personalized assistant agent 120b-d may interact with a human user through direct message on the messaging platform 110.

In one embodiment, a workflow agent or referred to as a collaborative specialist agent 125a may be configured to handle complex, multi-stage processes. The agent manages state and transitions toward sequential goals, guiding users through structured workflows step by step. For example, the collaborative specialist agent 125a may be finetuned on domain knowledge and/or action data 126. For instance, a collaboration manager agent 120a may determine when and whether to invoke domain agents such as a psychologist agent 120b, an economist agent 120c or a public health agent 120d.

In one embodiment, a proactive agent 125b may maintain persistent awareness of the conversation context on the messaging platform 110 and selectively intervenes when it can provide relevant, meaningful support—often unprompted. For example, the proactive agent 125b may be finetuned on channel knowledge and/or action data 127. A project management agent 120e, for instance, may constantly, periodically, and/or intermittently monitor conversation lines from a workgroup channel or thread involving human employees (user 102) and determine whether to intervene with a response, or to identify an issue and invoke any other agents such as 125a or 125c to address an identified issue.

In one embodiment, all agents of types 125a-c may be deployed as standalone applications. Each AI agent is trained to monitor for specific message patterns and equipped with messaging tools that enable them to communicate with users 102 and/or other agents. This setup supports multi-agent collaboration through structured protocols, allowing agents to coordinate seamlessly within communication threads and across channels on the messaging platform 110.

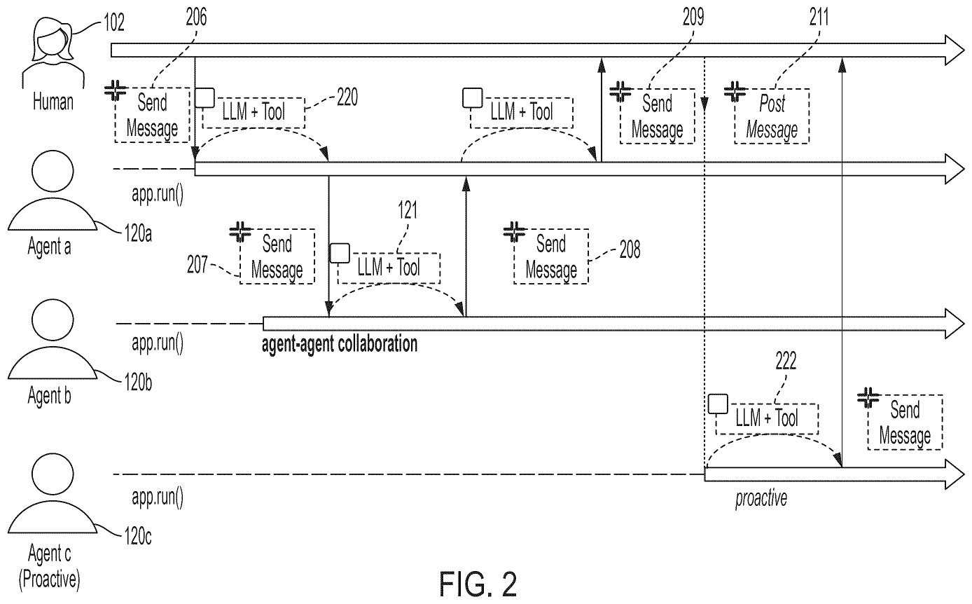

FIG. 2 is a simplified diagram illustrating an example multi-agent collaborative environment, according to some embodiments. As shown in FIG. 2, a multi-agent conversation may be conducted in a scalable and decentralized way. For example, agents 120a-c may collaborate on a conversation session on the messaging platform. Agents 120a-c may be integrated and initialized during the conversation session. For example, when a new agent is determined to be imported or initialized, an example code implementation of initializing an agent may take a form similar to:
from slackagents import SlackAssistant
agent_a=SlackAssistant(
name=name_agent_a,
desc=desc_agent_a,
system_prompt= . . . ,
tools=[ . . . ],
slack_bot_token= . . .
colleagues={
id_agent_b: {“name”:name_agent_b, “description”:desc_agent_b},
id_agent_c: {“name”:name_agent_c, “description”:desc_agent_c},
} #define the multi-agent collaboration
)
   Here the colleagues key argument defines the possible collaboration to its collaborative agents a and b.

In one embodiment, after all agents 120a-c are defined, each agent 120a-c is run as an independent application within the messaging platform 110. Built on a scalable message-handling backend, different types of conversation messages during an ongoing conversation session may be monitored in different ways. For example, a user 102 may send direct messages to an agent 120a through the platform's private messaging interface. A sample implementation for handling direct messages is shown below:
From Slack_bolt_id Import Bolt_config
from slackagents import SlackDMHandler
from slackagents import SlackDMAgent
if__name__==“__main__”:
agent=SlackDMAgent(name=name, desc=desc)
handler=SlackDMHandler(BOLT_CONFIG, agent)
handler.run( )
   An agent (e.g., 120a) can be initialized and registered as a Direct Message Handler to listen for incoming private messages.

For another example, in addition to direct messaging, the system also supports @-mentions within shared channels. This allows both user 102 and agents 120a-c to address specific agents in group conversations, enabling collaborative interaction across the team. A sample implementation is shown below:
from slack_bolt_id import BOLT_CONFIG
from slackagents import SlackChannelHandler
from slackagents import SlackAssistant
if__name__==“__main__”:
agent=SlackAssistant(name=name, desc=desc, colleagues=colleagues)
handler=SlackChannelHandler(BOLT_CONFIG, agent)
handler.run( )
   An agent can be defined using the system's assistant API and registered as a Channel Message Handler. The agent's colleagues—which can include other agents or human users—are specified as part of its configuration. This allows the agent to actively collaborate and reach out to others when assistance is needed.

In one embodiment, a user 102 may send the first message 206 directly to agent a 120a, e.g., either through direct messaging or an assigned message @-mentions agent 120a. Agent a 120a may decide, e.g., via the underlying LLM and tools 220, to ask the help from agent b 120b. For example, agent a 120a may receive an input of the message 206 and a system prompt guiding the agent a 120a for the next step, and generate a request 207 to agent b 120b. For example, the inter-agent communication 207 may be conducted though the Channel Message Handler, e.g., message 207 may @-mention agent b 120b. The underlying LLM and tools of agent b 120b may receive an input of message 207 and a system prompt guiding the LLM to generate a response message 208 back to agent a 120a, which may in turn respond a message 209 back to user 102. Thus agents 120a-b address the original user message 207 via agent-agent collaboration.

In one embodiment, when the user 102 posts a message 211 under the thread without mentioning any specific agent, a proactive agent 120c listens this message, e.g., by feeding the message to its underlying LLM 222 to generate a response, which identifies whether any issues needs to be responded from the post message 211, and/or any AI agent needs to be invoked to handle the identified issue. Proactive agent 120c may also respond towards the message (e.g., 209) sent from another agent. An example implementation of the proactive agent 120c may take a form similar to:
From Slack_bolt_id Import Bolt_config
from slackagents import SlackProactiveHandler
from slackagents import SlackAssistant
if__name__==“__main__”:
agent=SlackAssistant(name=name, desc=desc)
handler=SlackProactiveHandler(BOLT_CONFIG, agent)
handler.run( )
   Once the proactive agent 120c is activated in the backend, users can @ mention it in any messaging thread, enabling the proactive agent 120c to monitor all messages within that thread. The proactive agent 120c determines whether to participate in the discussion based on its capabilities, including system prompts and available tools. When the proactive agent 120c identifies a need for support, it automatically employs its tools and engages in the ongoing

conversation.

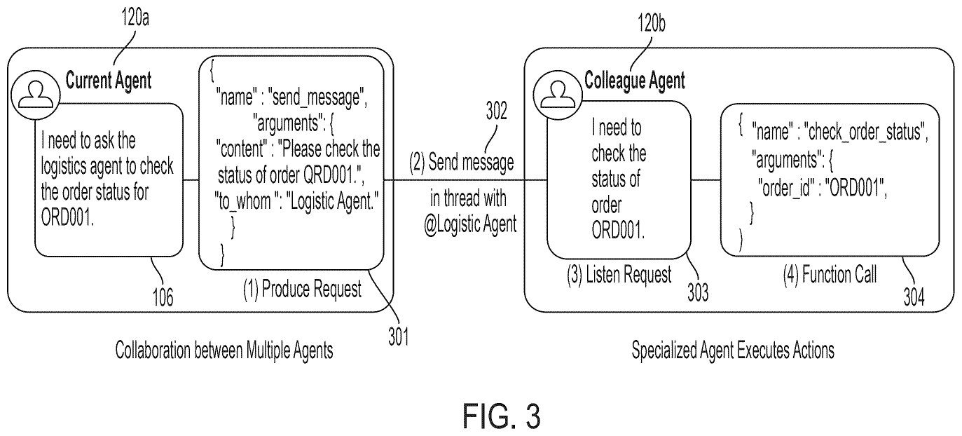

FIG. 3 is a simplified diagram illustrating an example implementation of collaborative agent actions, according to some embodiments. In one embodiment, each AI agent 120a-e may be designed for multi-agent collaboration within channel-based communication environments. Each agent may thus maintain awareness of both human and agent participants through a colleague system, enabling it to understand team composition and retain context about the roles and capabilities of different team members.

In one embodiment, the multi-agent collaboration in may be initiated for a current agent 120a to produce a message 106 that contains a request for assistance with @ mention of the chosen agents or human from a pre-defined colleague list, e.g., at 301. The current agent 120a may then send the message to the colleague(s) in a dedicated session, e.g., at 302. The current agent 120a may then listen for the colleague agent's 120b responses in the session, e.g., at 303. The colleague agent 120b may in turn generate a function call 304, e.g., to check an order status. This collaboration strategy may thus decentralized, asynchronous, and scalable by looping in colleagues for help in threads.

In one embodiment, function calling 304 serves as the communication protocol for generating collaboration requests from one agent to another. For example, three conversation tools—SEND MESSAGE, WAIT, and GET THREAD HISTORY—are incorporated into each assistant to support multi-agent collaboration within a channel-based communication session.

For example, the SEND MESSAGE protocol (e.g., 302) may be invoked when the current agent 120a determines that a conversation exceeds its own capabilities but aligns with the roles and expertise of another team member 120b, it executes a SEND MESSAGE 302 function. This action posts a message in the thread, formatted as “<@recipient>+content,” which is then received by the appropriate colleague agent via a listener mechanism, prompting that agent to respond and assist. An example SEND MESSAGE request sent between agents may take a form similar to:
{
“type”: “function”,
“function”: {
“name”: “send_message”,
“description”: “Send a message to one of your colleagues or to
the message sender.”,
“parameters”: {
“type”: “object”,
“properties”: {
“content”: {
“type”: “string”,
“description”: “The content of the message to be sent
.”
}
,
“to_whom”: {
“type”: “string”,
“description”: “The name of the recipient.”
}},
“required”: [“content”, “to_whom”],
“additionalProperties”: false
}}}

After sending a request, the agent 120a executes the WAIT function, ending its tool request loop and awaiting responses from colleague agents 120b. For example, the proactive agent behavior is mainly achieved through this function. An example WAIT request may take a form similar to:
{
“type”: “function”,
“function”: {
“name”: “wait”,
“description”: “Wait for the next message.”,
“parameters”: {
“type”: “object”,
“properties”: {
“reason”: {
“type”: “string”,
“description”: “The reason for waiting.”}
},
“required”: [“reason”],
“additionalProperties”: False }}}

All agents are equipped with GET THREAD HISTORY by default to obtain the past messages in the thread, in case the request message which has been sent is not informative enough.

### Computer and Network Environment

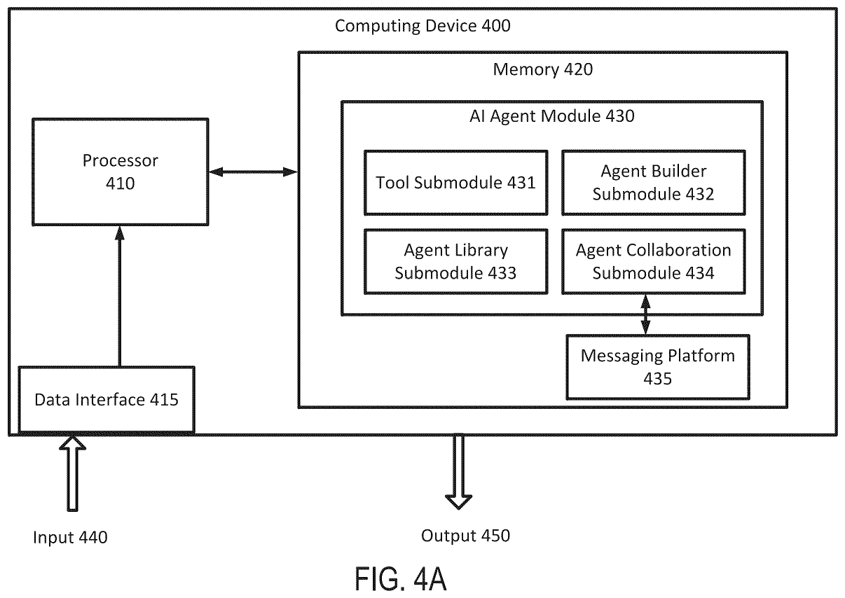

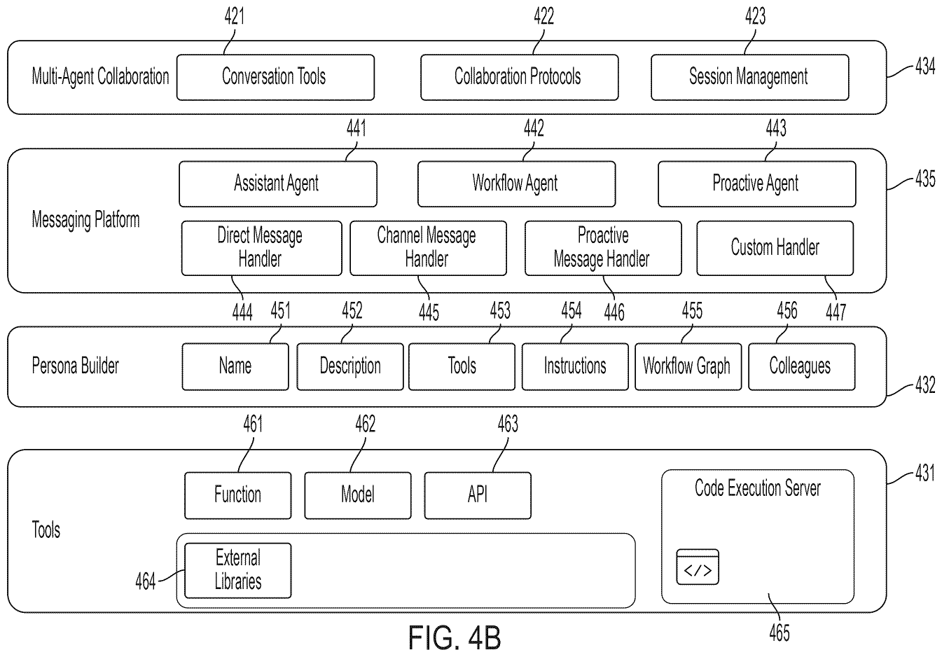

FIG. 4A is a simplified diagram illustrating a computing device implementing the framework described in FIGS. 1-3, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any

other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 5.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for AI agent module 430 that may be used to implement and/or emulate the systems and models, and/or to implement any of the methods described further herein. AI agent module 430 may receive input 440 such as an input training data via the data interface 415 and generate an output 450 which may be an answer.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a question, from a user via the user interface.

In some embodiments, the AI agent module 430 is configured to build and operate multiple AI agents on the messaging platform 435. The AI agent module 430 may further include a tool submodule 431, an agent builder submodule 432, agent library submodule 433, agent collaboration submodule 434. The submodules 431-434 may interact and/or operate with messaging platform 435 to jointly build and operate multiple agent collaboration integrated on the messaging platform 435. Additional details of submodules 431-434 may be described below in relation to FIG. 4B.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 4B provides an example architecture of the AI module 430 described in FIG. 4A, according to embodiments described herein.

In one embodiment, a multi-agent collaboration submodule 434 may further include conversation tools 421, collaboration protocols 422 and session management 423. For example, the conversation tools 421 may guide agents to exchange information and delegate tasks within shared communication channels, and collaboration protocols 422 define standardized procedures for initiating, managing, and responding to inter-agent requests. Additionally, the submodule 434 may incorporate session management 423 to maintain contextual awareness across ongoing interactions, track participant involvement, and ensure coherent progression of multi-agent workflows.

In one embodiment, on the messaging platform 435, a multi-agent library for building AI agents may be instantiated to automate routine tasks within channel-based communication platforms 435. As described in relation to FIG. 1B, multiple types of agents such as an assistant agent 441, workflow agent 442, and proactive agent 443 may be integrated onto messaging platform 435. The different types of agents 441-443 may interact via a direct message handler 444, a channel message handler 445, a proactive message handler 446 and/or other custom handlers 447.

In one embodiment, the builder submodule 432 may be configured to build a particular AI agent of a persona. For example, the builder submodule 432 may store name 451, description 452, tools 453 instructions 454 and/or other attributes associated with an AI agent. Additionally, the builder submodule 432 may build a workflow graph 455 for an AI agent and identify its colleagues 456.

For example, the multi-agent library provides a standardized method for designing individual AI agents that integrate with messaging platform 435 to perform specific tasks using various tools and language models. In one embodiment, developers may configure each agent's core attributes—name 451, description 452, language model, tools 453, and system prompt (instruction 454)—which collectively define the behavior of the built AI agent. The name 451 is a human-readable identifier displayed in the messaging interface; the description 452 briefly explains the agent's purpose; the language model (LLM) processes natural language input; the tools 453 enable task completion; and the system prompt 454 sets the context and behavioral guidelines. For example, an AI agent configured for brainstorming research ideas and writing paper abstracts can use this framework to search academic databases like ArXiv and generate relevant content directly within the messaging platform. An example code implementation for building an Assistant Agent may take a form similar to:
from slackagents import AssistantAgent
paper_abstract_agent=AssistantAgent(
name=“Paper Guru”,
desc=“Brainstorm abstracts for a given topic”,
llm=OpenAILLM(BaseLLMConfig(model=“gpt-4o”)),
tools=[arxiv_tool, abstract_writer_tool],
system_prompt=“You are an AI assistant that can help brainstorm an abstract for a given topic.”
)

For another example, the workflow agent 442 may be constructed by organizing individual agents into a structured directed graph 455, where each agent contributes to a shared objective. Although multiple agents are involved, the entire workflow functions as a single unified agent within the messaging platform 435. This abstraction allows users to interact with the workflow as if it were a single entity, while coordination among the underlying agents is handled automatically. The workflow agent 442 follows a defined, step-by-step process, providing a seamless and dependable user experience. In this way, the graph 455 specifies the execution sequence—each node represents an individual agent, and edges define how and when agents communicate or trigger each other's actions.

For instance, a set of agents may be arranged to collaboratively manage a quarterly check-in process through the messaging interface of the messaging platform 435. Fist, individual agents from the multi-agent library may be defined, e.g., using a code implementation executed by the code execution server 465:
From Slackagents Import AssistantAgent
data_agent=AssistantAgent(
name=“Data Agent”,
desc=“AI agent designed to generate a report for the quarterly check-in meeting with Jira record.”,
tools=[
FunctionTool.from_function(load_jira_record_tool),
FunctionTool.from_function(write_tool),
],
system_prompt=system_prompt,
verbose=True
)
calendar_agent=AssistantAgent(
name=“Calendar Agent”,
desc=“AI agent designed to load an employee's calendar and send the calendar invites”,
tools=[
FunctionTool.from_function(load_employee_calendar_tool),
FunctionTool.from_function(send_calendar_invite_tool)
],
system_prompt=system_prompt,
verbose=True
)
email_agent=AssistantAgent(
name=“Email Agent”,
desc=“AI agent designed to send emails to employees”,
tools=[FunctionTool.from_function(send_email_tool)],
system_prompt=system_prompt,
verbose=True
)

Next, an execution path that defines the workflow graph 455 may be generated:
from slackagents import ExecutionGraph, ExecutionTransition
graph=ExecutionGraph( )
graph.add_agent(data_agent)
graph.add_agent(calendar_agent)
graph.add_agent(email_agent)

Next, transitions between the multiple agents may be defined:
graph.add_transition(
ExecutionTransition(
source_module=graph.get_module(“Data Agent”),
target_module=graph.get_module(“Calendar Agent”),
desc=“After the report is written to the employee's local directory”))
graph.add_transition(
ExecutionTransition(
source_module=graph.get_module(“Data Agent”),
target_module=graph.get_module(“Email Agent”),
desc=“After the meeting is scheduled.”))

In one embodiment, the initial agent may thus be set in the workflow:
graph.set_initial_module(graph.get_module(“Data Agent”))

In one embodiment, the workflow is a higher-level construct that ties everything together, which encapsulates the agents and the execution graph into a single, reusable, and scalable process. Once the workflow is defined, it can be triggered in the messaging platform 435 to automate a series of tasks. An example code implementation of the workflow agent 442 may take a form similar to:
from slackagents import WorkflowAgent
quaterlycheckin_agent=WorkflowAgent(
name=“Quarterly Check-in Workflow”,
desc=“Workflow to automate quarterly check-in process”,
graph=graph
)

In this way, the workflow agent 442 ensures that the check-in process is automated on the messaging platform 435, starting with generating the report from Jira data dump, scheduling the meeting, and finally sending email notifications, all without human intervention.

In one embodiment, the tool submodule 431 may include fundamental actions that AI agents can perform, enabling the AI agents to interact with and control external systems and applications through function calling. Various methods for defining agent tools may be supported, each tailored to specific use cases, such as functions 461, models 462, APIs 463, and/or the like. Additionally, developers can incorporate tools from other external libraries 464—such as LangChain, LlamaIndex, CrewAI, and Composio—to enhance agent capabilities within the messaging platform 435.

In one embodiment, users and/or developers may define custom functions and convert them into function tools 461 that agents can use automatically by applying the FunctionTool.from_function method. For example, Python type hints may be incorporated along with standard docstrings that describe the function's inputs and outputs. The framework supports multiple docstring formats, including ReST, Google, NumPy, and Epydoc styles. Additionally, all functions wrapped with FunctionTool benefit from built-in automatic error handling, enhancing reliability during agent execution. An example code implementation for defining a function tool may take a form similar to:
from slackagents.tools.function_tool import FunctionTool
def calculate_area(length: float, width: float)->float:
“““
Calculate the area of a rectangle.
:param length: The length of the rectangle.
:param width: The width of the rectangle.
:return: The area of the rectangle.
”””
Return Length*Width
Tool=Functiontool.from_function(calculate_area)

In one embodiment, in addition to using function docstrings, developers may explicitly define agent tools using a Pydantic data model. Pydantic is a data validation library that leverages Python type annotations to manage and validate structured data. By creating a Pydantic model tool 462 for a function, developers may clearly specify the expected input and output types. In this way, the model tools 462 may be provided to ensure that the JSON schema used by the language model matches the defined structure, provides a clearer visualization of the tool's specification, and enables automatic input validation for more robust agent behavior. An example code implementation for defining a model tool may take a form similar to:
From Slackagents.tools.function_tool Import FunctionTool
from pydantic import BaseModel, Field
class CalculateArea(BaseModel):
length:float=Field( . . . , description=“Length of the rectangle”)
width:float=Field( . . . , description=“Width of the rectangle”)
@classmethod
def execute(cls, length: float, width: float):
return length*width
tool=FunctionTool.from_pydantic(
model=CalculateArea,
name=“calculate_area”,
description=“Calculate the area of a rectangle”

In one embodiment, AI agents may automatically also define tools using OpenAPI JSON files to interface with RESTful APIs 463. Since many modern digital services expose functionality through standard HTTP methods like GET and POST, using OpenAPI specifications provides an efficient way to configure these tools without writing custom functions or Pydantic models. By referencing a folder of OpenAPI JSON files, AI agents may automatically access a wide range of external APIs. The framework also supports multiple authentication methods—including API keys (via headers or parameters), bearer tokens, and basic authentication with username and password—ensuring secure and flexible credential management. An example code implementation for defining a function tool through OpenAPI may take a form similar to:
from slackagents.tools.function_tool import FunctionTool
tool_schema= . . . #load a openapi json file
tool=OpenAPITool(
name=“api_name”,
openapi_spec=tool_schema,
auth_type=AuthType.NO_AUTH)
)

Additionally, users and/or developers may import the appropriate external tools from the pool of 1,000+ public, open-source tools.

FIG. 5 is a simplified diagram illustrating the neural network structure implementing the AI agent module 430 described in FIG. 4, according to some embodiments. In some embodiments, the AI agent module 430 and/or one or more of its submodules 431-433 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4), such as a user query. The number of nodes (neurons) in the input layer 441 may be determined by the dimensionality of the input data (e.g., the length of a vector of the user query). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4, the AI agent module 430 receives an input 440 of a user query and transforms the input into an output 450 of an answer. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI agent module 430 and/or one or more of its submodules 431-433 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a Transformer based LLM such as GPT, and/or the like.

In one embodiment, the AI agent module 430 and its submodules 431-433 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of ANN 600 that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM may receive a natural language input (such as a question) and generate a natural language output (such as an answer to the question).

In one embodiment, the AI agent module 430 and its submodules 431-433 may be implemented by hardware, software and/or a combination thereof. For example, the AI agent module 430 and its submodules 431-433 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the AI agent module 430 and its submodules 431-434 and/or any other neural network models in FIG. 4B onto hardware platform 460, the neural network based modules 430 and its submodules 431-434 may be optimized for deployment by converting it to a suitable format, such as ONNX or TensorRT, to improve performance and compatibility. Next, depending on the size and workload requirements for modules 430 and its submodules 431-434, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the AI agent module 430 and its submodules 431-434 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the AI agent module 430 and its submodules 431-434 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the AI agent module 430 and its submodules 431-433 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the AI agent module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based AI agent module 430 and one or more of its submodules 431-433 may be trained by iteratively updating the underlying parameters (e.g., weights 451, 452, etc., bias parameters and/or coefficients in the activation functions 461, 462 associated with neurons) of the neural network based on the loss. For example, during forward propagation, the training data such as pipeline generated unanswered queries are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding answers) from the training data, to compute a loss function that measures the discrepancy between the predicted output and the expected output. For example, the loss function may be cross entropy, minimum mean square error, and/or the like. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based AI agent module 430 and one or more of its submodules 431-433 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

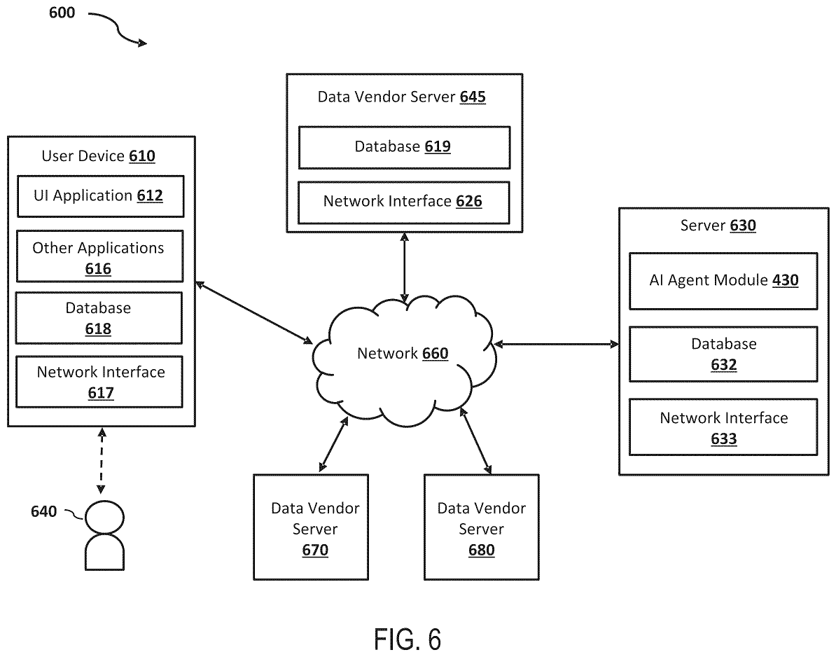

In some embodiments, AI agent module 430 and its submodules 431-433 may be housed at a centralized server (e.g., computing device 400) or one or more distributed servers. For example, one or more of AI agent module 430 and its submodules 431-433 may be housed at external server(s). The different modules may be communicatively coupled by building one or more connections through application programming interfaces (APIs) for each respective module. Additional network environment for the distributed servers hosting different modules and/or submodules may be discussed in FIG. 6.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as handling unseen queries in a new domain.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in medical diagnostics, and/or the like.

FIG. 6 is a simplified block diagram of a networked system 600 suitable for implementing the AI conversation framework described in FIGS. 1-5 and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a response from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the AI agent module 430 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which AI agent module 430 may generate a response via the process described in FIGS. 1-5. The AI agent module 430 may thus cause a display of a response at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view a response to the user query.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including query-answer pairs to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the AI agent module 430 and its submodules described in FIG. 4A. In some implementations, AI agent module 430 may receive data from database 619 at the data vendor server 645 via the network 660 to generate a response. The generated response may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the AI agent module 430. In one implementation, the database 632 may store previously generated responses, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

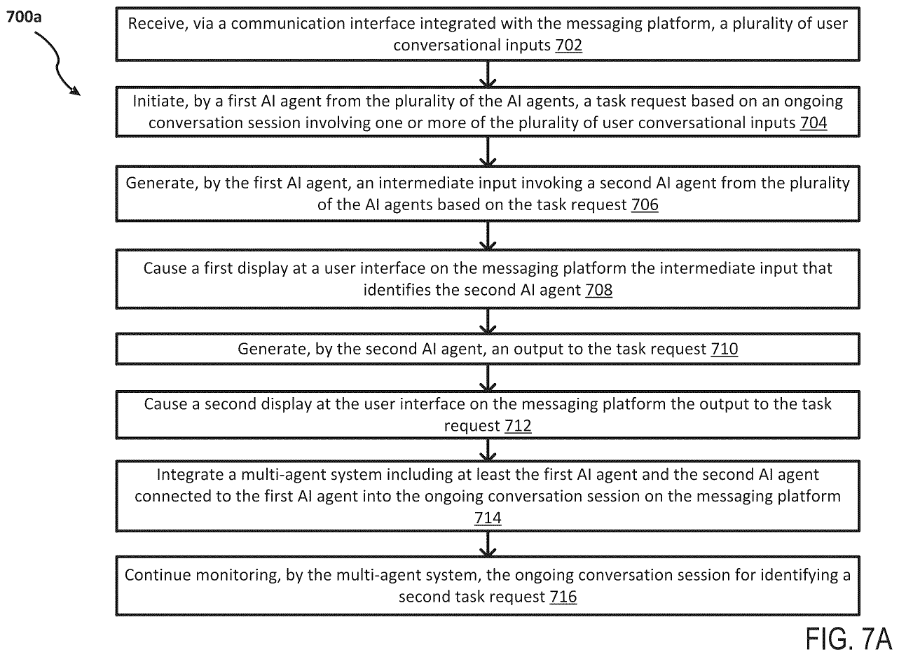

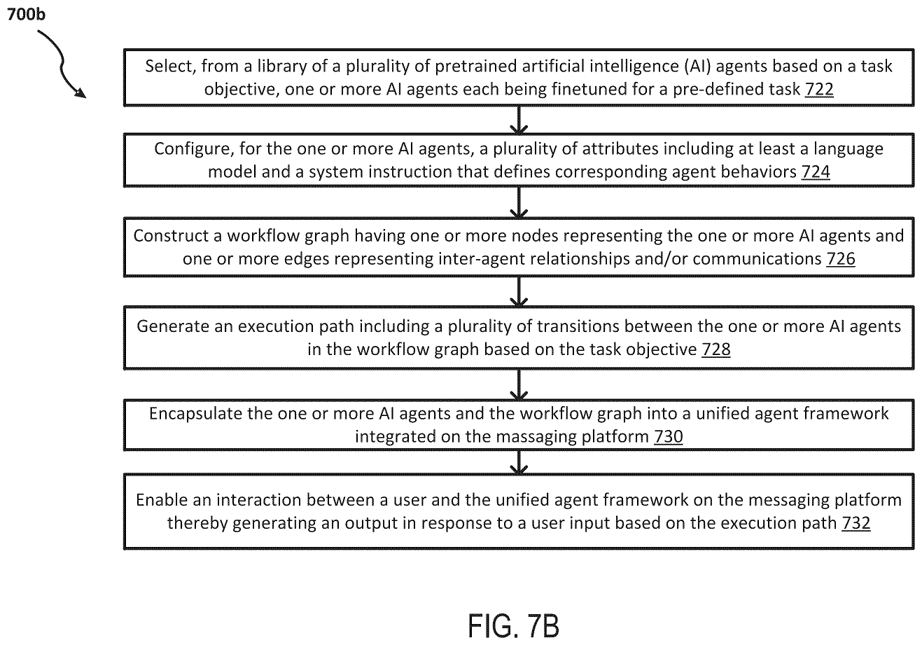

FIG. 7A provides an example logic flow diagram illustrating a method of operating a collaborative multi-agent system at a messaging platform based on the framework shown in FIGS. 1-6, according to some embodiments described herein. One or more of the processes of method 700a may be implemented, at least in part, in the form of executable code stored on non-transitory, tangible, machine-readable media that when run by one or more processors may cause the one or more processors to perform one or more of the processes. In some embodiments, method 700 corresponds to the operation of the AI agent module 730 (e.g., FIGS. 4 and 6) that build and operate a multi-agent system integrated on a messaging platform.

In some embodiments, method 700a is performed by a system such as computing device 400, user device 610, server 630, or another device or combination of devices. Inputs (e.g., a problem specification) may be received via a data interface such as data interface 415, network interface 617, network interface 633, or via a data interface that is integrated with a device. For example UI Application 612 may receive user inputs via a text input interface (e.g., keyboard), audio input (e.g., microphone), video interface (e.g., camera), or other interface for receiving user inputs (e.g., a mouse or touch display).

As illustrated, the method 700a includes a number of enumerated steps, but aspects of the method 700a may include additional steps before, after, and in between the enumerated steps. In some aspects, one or more of the enumerated steps may be omitted or performed in a different order.

At step 702, a communication interface (e.g., 415 in FIGS. 4, 633 in FIG. 6) integrated with the messaging platform (e.g., 110 in FIG. 1) may receive a plurality of user conversational inputs. For example, the plurality of user conversational inputs are received from multiple users accessing the ongoing conversation session.

At step 704, a first AI agent (e.g., 120a in FIG. 2) from the plurality of the AI agents, may receive a task request (e.g., 206 in FIG. 2) based on an ongoing conversation session involving one or more of the plurality of user conversational inputs. For example, the task request is initiated by the first AI agent monitoring the plurality of user conversational inputs from the ongoing conversation session, combining at least a subset of the plurality of user conversation inputs into a conversation context to the first AI agent, and generating, by an underlying LLM of the first AI agent, the task request based on the conversation context. In some implementations, the automatically identified task request may be confirmed via the user interface on the messaging platform, e.g., by generating a question to the user “would you like to confirm the order status of order number 4XX.” In another example, the task request may be initiated by the first AI agent upon detecting the task request that is mentioned in the plurality of user conversational inputs, e.g., the user sends a direct message to the first AI agent, or mentions the first AI agent in a conversation input in a thread.

At step 706, the first AI agent (e.g., 120a in FIG. 2) may generate an intermediate input (e.g., 207 in FIG. 2) invoking a second AI agent (e.g., 120b in FIG. 2) from the plurality of the AI agents based on the task request. For example, the intermediate input includes one or more of a code script for execution by the second AI agent, and a text description (e.g., a prompt) of a transferred task request to the second AI agent.

At step 708, the messaging platform (e.g., 110 in FIG. 1) may cause a first display at a user interface (e.g., 107 in FIG. 1) on the messaging platform the intermediate input that identifies the second AI agent.

At step 710, the second AI agent (e.g., 120b in FIG. 2) may generate an output (e.g., 208 in FIG. 2) to the task request.

At step 712, the messaging platform (e.g., 110 in FIG. 1) may cause a second display at the user interface (e.g., 107 in FIG. 1) on the messaging platform the output to the task request.

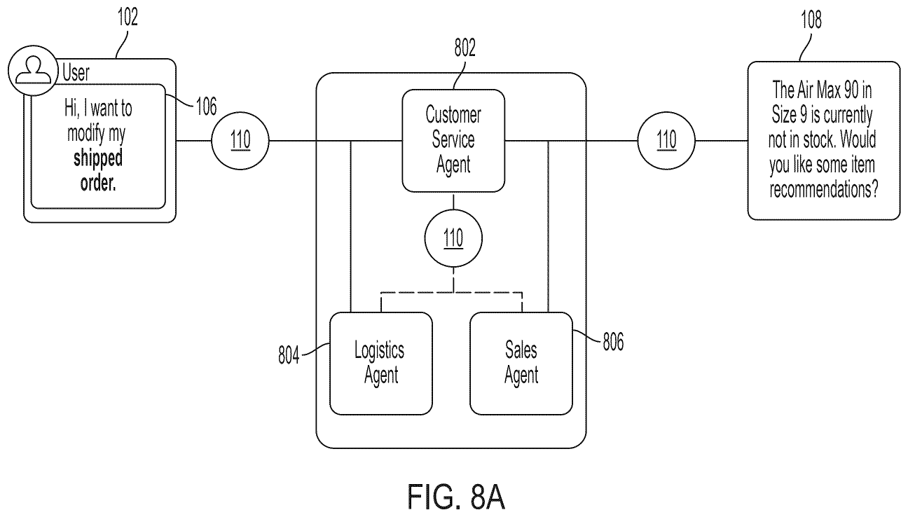

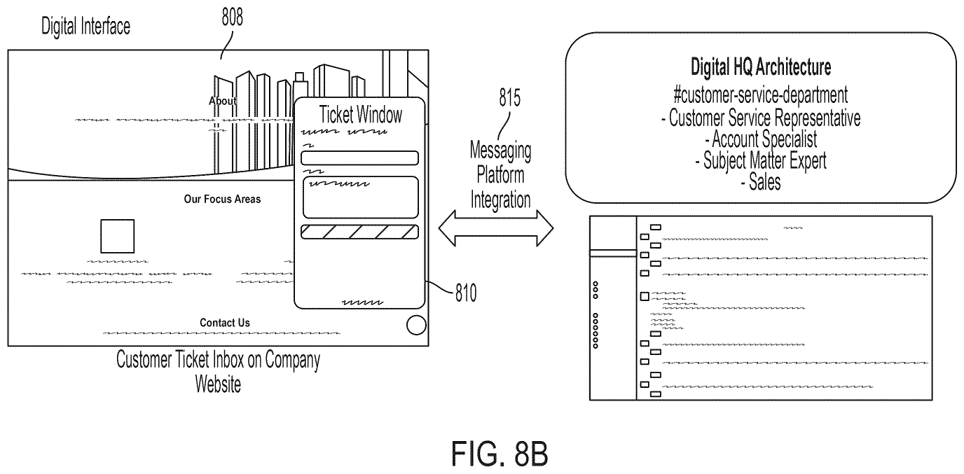

At step 714, a multi-agent system (e.g., FIGS. 8A, 9, 10) including at least the first AI agent and the second AI agent connected to the first AI agent may integrated into the ongoing conversation session on the messaging platform. For example, the first AI agent and the second AI agent is integrated into a single workflow of a sequence of steps for execution such that a user may interact with the single workflow. The single workflow is generated by selecting the first AI agent and the second AI agent from the library, and building an execution graph including a plurality of nodes representing the first AI agent and the second AI agent and a plurality of edges representing transitions between the first AI agent and the second AI agent.

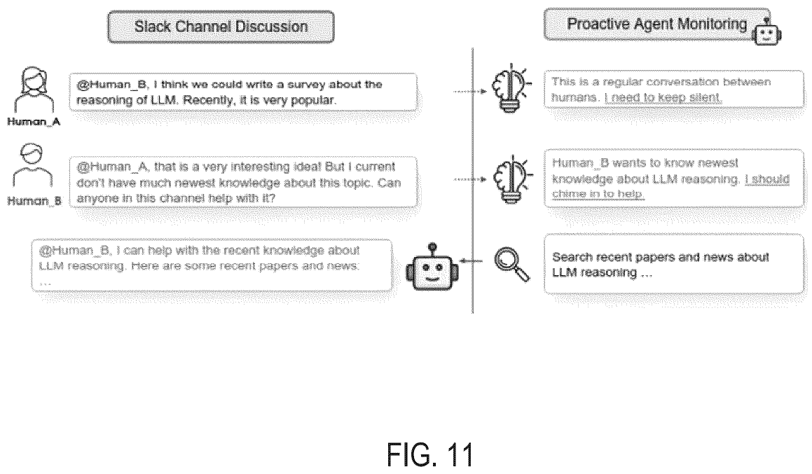

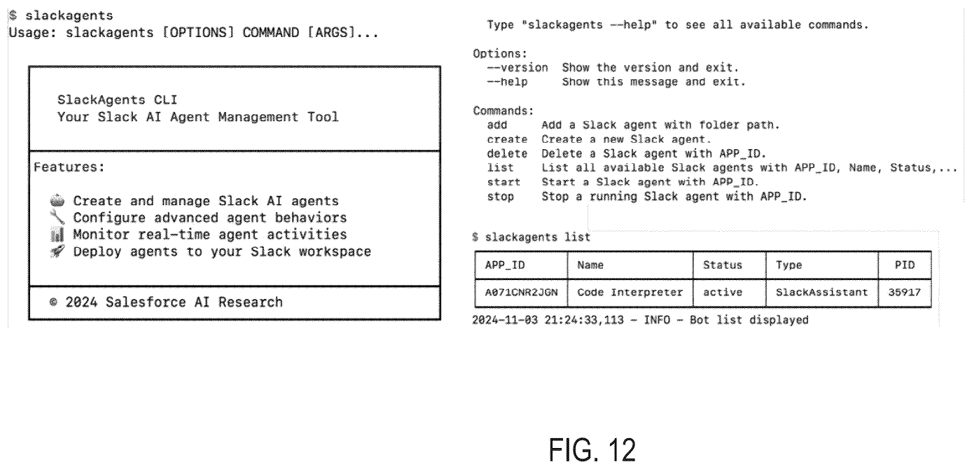

At step 716, the multi-agent system may continue monitor the ongoing conversation session for identifying a second task request. For example, the second task request is identified from the ongoing conversation by the multi-agent system by analyzing each new conversation input in real time, or a collection of conversation inputs asynchronously. In some implementations, a configuration command may be received for the first AI agent or the second AI agent through a command-in-line user interface (e.g., FIG. 11) or a visualized user interface (e.g., FIG. 12).

FIG. 7B provides an example logic flow diagram illustrating a method of building collaborative multi-agent system at a messaging platform based on the framework shown in FIGS. 1-6, according to some embodiments described herein. One or more of the processes of method 700b may be implemented, at least in part, in the form of executable code stored on non-transitory, tangible, machine-readable media that when run by one or more processors may cause the one or more processors to perform one or more of the processes. In some embodiments, method 700b corresponds to the operation of the AI agent module 730 (e.g., FIGS. 4 and 6) that build and operate a multi-agent system integrated on a messaging platform.

In some embodiments, method 700b is performed by a system such as computing device 400, user device 610, server 630, or another device or combination of devices. Inputs (e.g., a problem specification) may be received via a data interface such as data interface 415, network interface 617, network interface 633, or via a data interface that is integrated with a device. For example UI Application 612 may receive user inputs via a text input interface (e.g., keyboard), audio input (e.g., microphone), video interface (e.g., camera), or other interface for receiving user inputs (e.g., a mouse or touch display).

As illustrated, the method 700b includes a number of enumerated steps, but aspects of the method 700b may include additional steps before, after, and in between the enumerated steps. In some aspects, one or more of the enumerated steps may be omitted or performed in a different order.

At step 722, the system (e.g., the architecture shown in FIG. 4B) may select, from a library of a plurality of pretrained AI agents (e.g., 125a0c in FIG. 1B) based on a task objective (e.g., a user description of the task), one or more AI agents (e.g., 120a-c in FIG. 1B and FIG. 2) each being finetuned for a pre-defined task. For example, the plurality of AI agents includes one or more of: a collaborative specialist agent (e.g., 125a in FIG. 1B) configured to generate multiple workflows through different perspective inputs for the task request, a proactive support agent (e.g., 125b in FIG. 1B) configured to monitor the ongoing conversation session on the messaging platform and initiating a task request without direct invocation, and a personal assistant agent (e.g., 125c in FIG. 1B) trained on user prior dialogue and task data.

At step 724, the system may configure, for the one or more AI agents, a plurality of attributes including at least a language model and a system instruction that defines corresponding agent behaviors. For example, the plurality of attributes further comprise a name, a description, and one or more executable agent tools (e.g., 431 in FIG. 4B) to operate with the language model. The one or more executable agent tools comprise one or more of: function tools (e.g., 461 in FIG. 4B) generated from custom functions with type hints and docstrings, model tools (e.g., 462 in FIG. 4B) defined using Pydantic models for input/output validation, API tools (e.g., 463 in FIG. 4B) defined for RESTful integration, and external library tools incorporated from third-party sources.

At step 726, the system may construct a workflow graph (e.g., 455 in FIG. 4B) having one or more nodes representing the one or more AI agents and one or more edges representing inter-agent relationships and/or communications.

At step 728, the system may generate an execution path including a plurality of transitions between the one or more AI agents in the workflow graph based on the task objective.

At step 730, the system may encapsulate the one or more AI agents and the workflow graph into a unified agent framework integrated on the massaging platform (e.g., 435 in FIG. 4B). For example, the unified agent framework is integrated on the messaging platform through one or more message handlers selected from a group consisting of: a direct message handler, a channel message handler, a proactive message handler, and a custom handler.

At step 732, the system may enable an interaction between a user and the unified agent framework on the messaging platform thereby generating an output in response to a user input based on the execution path.

In some embodiments, the built AI agent is applicable in a variety of applications. For example, a user request received may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing embodiments described herein, the neural network based artificial agent may improve technology in the respective technical field in healthcare and diagnostics, education and personalized learning, software development and code assistance, content creation, autonomous system (such as autonomous driving, etc.), and/or the like.

FIGS. 8A and 8B provide simplified diagrams illustrating an example application of an autonomous customer service agent team on the messaging platform, according to embodiments described herein. As shown in FIG. 8A, a customer service team of agents may be built on the messaging platform 110. For example, a multi-agent system may be implemented to enhance customer support operations for an e-commerce company. The multi-agent system may include three specialized agents—Customer Service Agent 802, Sales Agent 804, and Logistics Agent 806—each responsible for distinct aspects of customer interaction while collaboratively to provide a response 108 to the user request 106. The Customer Service Agent 802 acts as the main interface, addressing a user request 106 about order status, cancellations, modifications, and product recommendations. Depending on the request 106, Customer Service Agent 802 coordinates with the Logistics Agent 804 for order-related information or the Sales Agent 806 for product-specific support. The Logistics Agent 804 handles fulfillment and shipping tasks, providing updates on delivery status, estimated arrival times, and confirming cancellations. The Sales Agent 806 manages inventory checks, personalized product recommendations, and order adjustments, and applies upselling or cross-selling strategies when relevant. The multi-agent framework supports a flexible collaboration model, allowing users 102 to either engage the Customer Service Agent 802 as a central coordinator or directly interact with specialized agents for targeted assistance, ensuring both responsiveness and task-specific accuracy.

In one embodiment, the multi-agent framework for customer service may build an autonomous customer service department to streamline support operations. For example, as shown in FIG. 8B, a customer ticket inbox widget 810 may be developed, which can be embedded on any website to collect customer inquiries and enable live chat functionality. This widget 810 serves as the initial point of contact, capturing support tickets in real time.

To integrate this functionality into workplace communication, the ticket inbox 810 may be connected to the multi-agent framework and deployed as an agent within a messaging platform 815. Incoming tickets are automatically forwarded to a dedicated customer service channel, where AI agents can review and respond. Customers can also engage in live chat directly through the channel, interacting with AI agents in real time. This setup allows for centralized ticket handling and immediate, automated responses, creating a responsive and efficient customer service workflow.

In this example, the customer service department may be structured around a team of specialized AI agents within a multi-agent framework, each designed to handle specific roles and tasks in resolving support tickets efficiently and collaboratively. A Customer Service Representative Agent 802—Jane may act as the primary interface with customers and is the only agent permitted to communicate directly through the customer-facing website inbox 810. As the lead AI agent, Jane 802 may manage the initial intake and coordination of customer issues. Its behavior is governed by a state machine tailored to a specific use case. Upon receiving a ticket, Jane introduces itself and the company. If the problem description lacks technical clarity—such as in cases involving API limit issues—Jane 802 requests detailed information, including license details, error messages, and network settings. If the issue pertains to account access or management, Jane 802 escalates it internally and initiates credential verification. Once verified, Jane 802 summarizes the problem for customer confirmation, allowing additional input if needed. Jane 802 then delegates tasks to other agents and coordinates troubleshooting while keeping the customer informed throughout the process.

The Account Specialist—Kate may be responsible for handling database-level operations related to customer accounts. Its primary tasks include generating account health reports and upgrading account editions to resolve API limitations. Kate may be activated by requests from colleagues and, upon doing so, runs diagnostics from internal databases or initiates edition upgrades after customer approval. Kate then communicates its findings or actions back to the team to support continued case resolution.

The Subject Matter Expert—John may serve as the internal expert on Salesforce API limits, quotas, and pricing across different editions. John has access to proprietary internal documentation and knowledge bases. When referenced in the messaging platform for technical questions, John uses retrieval-augmented generation (RAG) techniques to search relevant information and deliver detailed answers to colleagues, supporting them in guiding customers toward viable solutions.

Sales Agent—Sam handles sales engagement once a customer expresses interest in product upgrades. Sam performs outbound phone calls through an integrated voice AI system and transcribes the conversations. After speaking with a customer, Sam summarizes the discussion and reports the outcome to the team, helping to close the sales loop and ensure smooth handoffs between service and sales functions.

Together, these agents form a cohesive and adaptive AI-powered customer service team, each contributing specialized knowledge and actions within a unified collaborative workflow.

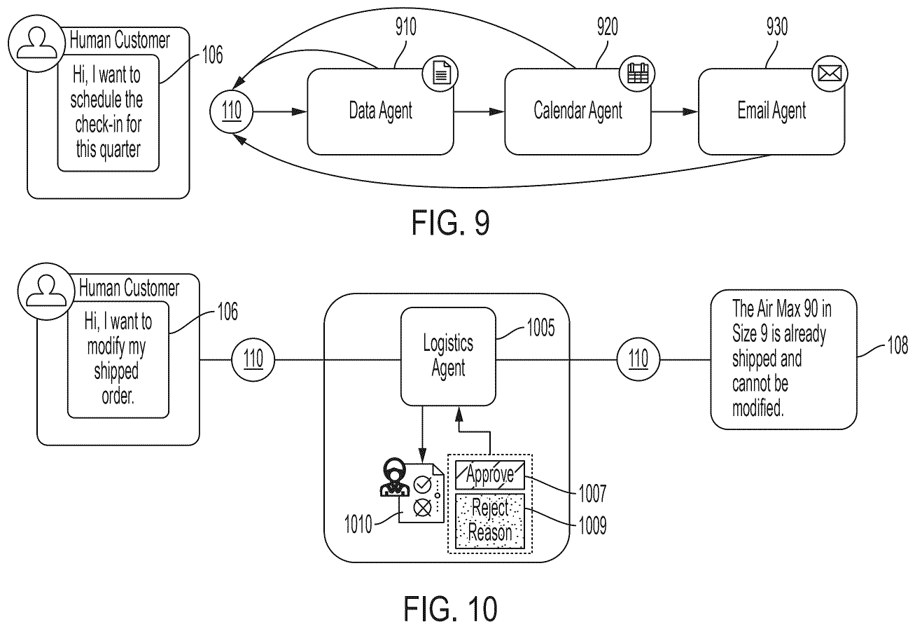

FIG. 9 is a simplified diagram illustrating an example application of a periodic check-in agent on the messaging platform, according to embodiments described herein. The Periodic Check-In Workflow shown in FIG. 9 illustrates how a multi-agent framework can automate structured organizational processes, specifically the quarterly employee review cycle. This workflow is composed of specialized agents that collaboratively handle distinct stages of the process, including performance data analysis, scheduling, and communication. By modularizing responsibilities among agents—such as the Data Agent 910, Calendar Agent 920, and Email Agent 930—the multi-agent system ensures streamlined task execution and coordinated automation.

The process begins with the Data Agent 910, upon receiving a user request 106 via messaging platform 110, gathers and synthesizes performance data from sources like project management tools to generate a comprehensive report. This report incorporates both quantitative metrics and qualitative input collected through interactions with employees, offering a well-rounded view of progress, challenges, and goals. The result is a markdown summary that supports informed, productive conversations between employees and managers during check-ins.

Once the performance report is complete, the workflow transitions to the Calendar Agent 920. This agent 920 intelligently scans employee calendars to determine optimal meeting times, factoring in work hours, existing commitments, and individual scheduling preferences. It identifies the most convenient and conflict-free slots, sometimes offering multiple options for flexibility and employee input.

The final step is handled by the Email Agent 930, which sends out personalized messages containing meeting details and links to the performance reports. This agent ensures that all participants are well-informed ahead of their check-ins, enhancing the clarity and effectiveness of the communication process. Together, the agents demonstrate how a collaborative AI system can support human-centered organizational routines with efficiency and personalization.

FIG. 10 is a simplified diagram illustrating an example application of a verification agent on the messaging platform, according to embodiments described herein. A human-in-the-loop mechanism may be integrated into a multi-agent framework to enhance trust and oversight during tool usage. This design is exemplified in a logistics agent 1005 tasked with checking or updating order statuses. In addition to generating and executing tool calls, the agent 1005 operates with an embedded verification loop that introduces a decision checkpoint before any action is taken.

In this loop, the logistics agent 1005 submits a tool call request, which must be reviewed by a verifier 1010—either a human or another agent—who approves 1007 or rejects 1009 the request with an explanation. Upon receiving a response, the logistics agent 1005 either proceeds with executing the approved tool call or generates a revised message 108 via messaging platform 110 based on the rejection feedback.

This approach showcases the framework's flexibility in supporting trustworthy AI operations. By incorporating an external verification layer into the agent's workflow, developers can ensure more controlled and auditable decision-making, particularly in high-stakes or sensitive environments.

FIG. 11 is a simplified diagram illustrating an example application of a channel assistant agent on the messaging platform, according to embodiments described herein. As shown in FIG. 11, an intelligent and context-aware assistant can be embedded within a messaging platform 110 to support workplace collaboration more naturally and effectively. Unlike traditional chatbots that respond to every mention or follow rigid rules, this assistant operates with contextual awareness—monitoring ongoing conversations to identify moments where its contribution would be meaningful. It engages only when directly addressed or when it detects that its input could add value, ensuring that its involvement enhances rather than disrupts team dynamics. This assistant may remain unobtrusive during informal or irrelevant exchanges, stepping in selectively during critical discussions or decision points. This deliberate participation helps preserve the natural flow of communication while ensuring that important questions and tasks are not overlooked.

By shifting from a reactive chatbot model to an intelligent collaborator, this assistant serves as a dynamic team member. It streamlines workflows, encourages more effective communication, and ultimately improves overall productivity by offering support at precisely the right moments.

FIG. 12 is a simplified diagram illustrating a command-in-line (CLI) user interface for the multi-agent framework, according to embodiments described herein. The CLI for the multi-agent framework offers a unified toolset for managing AI agents within a messaging platform workspace. It supports a range of operations, including listing, deploying, and configuring agents, making it a practical interface for developers and administrators overseeing multi-agent systems.

Users can begin by running a command to list all available agents, providing visibility into the current workspace configuration. For detailed usage of any command, the—help flag supplies contextual guidance. Each CLI operation is case-sensitive and includes input validation to ensure accurate execution. Additionally, maintaining a record of application identifiers (APP IDs) is essential for agent-specific actions such as updates or deletions. This structured and user-friendly interface streamlines agent management across collaborative environments. Example commands may include:
create Interactive wizard for new agent creation
add [FOLDER PATH] Register existing agent from specified directory
list Display agents with APP ID, name, status, and type (--verbose for details)
start [APP ID] Launch specified agent
stop [APP ID] Terminate specified agent
delete [APP ID] Remove agent and associated resources

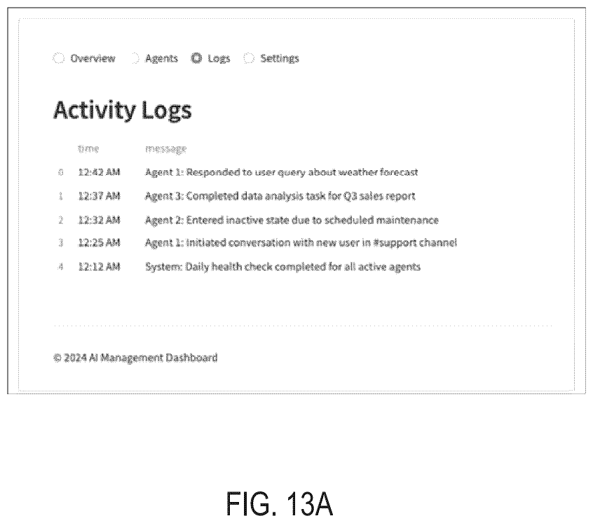

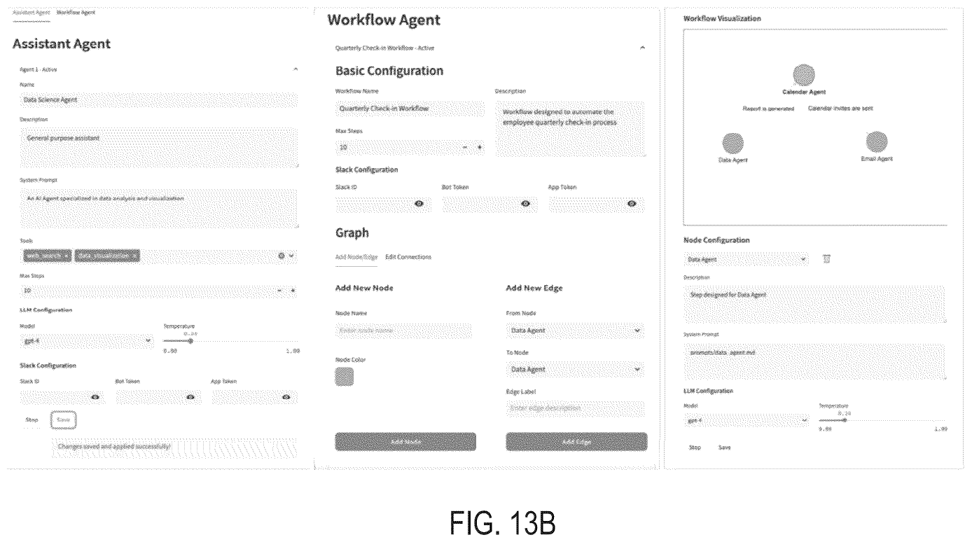

FIGS. 13A-13B provide simplified diagram illustrating a dashboard interface for the multi-agent framework, according to embodiments described herein. The dashboard interface acts as a centralized interface for overseeing AI agents, tools, and workflows within the multi-agent framework. It offers real-time monitoring of system operations, including agent performance, task flow, and platform health. Key functionalities include user access control, dynamic tool configuration, and in-depth analytics on agent interactions.

Users may track agent activities, fine-tune tool parameters, and resolve issues directly through the dashboard. One notable capability is runtime configurability—administrators can modify an agent's behavior and settings through the user interface without requiring a system restart, ensuring uninterrupted and adaptive system operation.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A system for collaborative multi-agent implementation at a messaging platform, the system comprising:
a communication interface integrated with the messaging platform for receiving a plurality of user conversational inputs;
a memory storing a library of a plurality of artificial intelligent (AI) agents, and a plurality of processor-executable instructions;
one or more hardware processors executing the plurality of processor-executable instructions to perform operations including:
initiating, by a first AI agent from the plurality of the AI agents, a task request based on an ongoing conversation session involving one or more of the plurality of user conversational inputs;
generating, by the first AI agent, an intermediate input invoking a second AI agent from the plurality of the AI agents based on the task request;
causing a first display at a user interface on the messaging platform the intermediate input that identifies the second AI agent;
generating, by the second AI agent, an output to the task request;
causing a second display at the user interface on the messaging platform the output to the task request;
integrating a multi-agent system including at least the first AI agent and the second AI agent connected to the first AI agent into the ongoing conversation session on the messaging platform; and
continuing monitoring, by the multi-agent system, the ongoing conversation session for identifying a second task request.

2. The system of claim 1, wherein the plurality of AI agents includes one or more of:
a collaborative specialist agent configured to generate multiple workflows through different perspective inputs for the task request;
a proactive support agent configured to monitor the ongoing conversation session on the messaging platform and initiating the task request without direct invocation; and
a personal assistant agent trained on user prior dialogue and task data.

3. The system of claim 1, wherein the plurality of user conversational inputs are received from multiple users accessing the ongoing conversation session.

4. The system of claim 1, wherein the task request is initiated by:
monitoring, by the first AI agent, the plurality of user conversational inputs from the ongoing conversation session;
combining at least a subset of the plurality of user conversation inputs into a conversation context to the first AI agent;
generating, by the first AI agent, the task request based on the conversation context; and
confirming, via the user interface on the messaging platform, the task request with one or more users.

5. The system of claim 1, wherein the task request is initiated by the first AI agent upon detecting the task request that is mentioned in the plurality of user conversational inputs.

6. The system of claim 1, wherein the second task request is identified from the ongoing conversation by the multi-agent system by analyzing:
each new conversation input in real time; or
a collection of conversation inputs asynchronously.

7. The system of claim 1, wherein the first AI agent and the second AI agent is integrated into a single workflow of a sequence of steps for execution.

8. The system of claim 7, wherein the single workflow is generated by:
selecting the first AI agent and the second AI agent from the library; and
building an execution graph including a plurality of nodes representing the first AI agent and the second AI agent and a plurality of edges representing transitions between the first AI agent and the second AI agent.

9. The system of claim 1, wherein the intermediate input includes one or more of:
a code script for execution by the second AI agent; and
a text description of a transferred task request to the second AI agent.

10. The system of claim 1, wherein the operations further include:
receive a configuration command for the first AI agent or the second AI agent through a command-in-line user interface or a visualized user interface.

11. A computer-implemented method for collaborative multi-agent implementation at a messaging platform, the method comprising:
receiving, via a communication interface integrated with the messaging platform, a plurality of user conversational inputs;
initiating, by a first artificial intelligence (AI) agent from the plurality of the AI agents, a task request based on an ongoing conversation session involving one or more of the plurality of user conversational inputs;
generating, by the first AI agent, an intermediate input invoking a second AI agent from the plurality of the AI agents based on the task request;
causing a first display at a user interface on the messaging platform the intermediate input that identifies the second AI agent;
generating, by the second AI agent, an output to the task request;
causing a second display at the user interface on the messaging platform the output to the task request;
integrating a multi-agent system including at least the first AI agent and the second AI agent connected to the first AI agent into the ongoing conversation session on the messaging platform; and
continuing monitoring, by the multi-agent system, the ongoing conversation session for identifying a second task request.

12. The method of claim 11, wherein the plurality of AI agents includes one or more of:
a collaborative specialist agent configured to generate multiple workflows through different perspective inputs for the task request;
a proactive support agent configured to monitor the ongoing conversation session on the messaging platform and initiating the task request without direct invocation; and
a personal assistant agent trained on user prior dialogue and task data.

13. The method of claim 11, wherein the plurality of user conversational inputs are received from multiple users accessing the ongoing conversation session.

14. The method of claim 11, wherein the task request is initiated by:
monitoring, by the first AI agent, the plurality of user conversational inputs from the ongoing conversation session;
combining at least a subset of the plurality of user conversation inputs into a conversation context to the first AI agent;
generating, by the first AI agent, the task request based on the conversation context; and
confirming, via the user interface on the messaging platform, the task request with one or more users.

15. The method of claim 11, wherein the task request is initiated by the first AI agent upon detecting the task request that is mentioned in the plurality of user conversational inputs.

16. The method of claim 11, wherein the second task request is identified from the ongoing conversation by the multi-agent method by analyzing:
each new conversation input in real time; or
a collection of conversation inputs asynchronously.

17. The method of claim 11, wherein the first AI agent and the second AI agent is integrated into a single workflow of a sequence of steps for execution.

18. The method of claim 17, wherein the single workflow is generated by:
selecting the first AI agent and the second AI agent from the library; and
building an execution graph including a plurality of nodes representing the first AI agent and the second AI agent and a plurality of edges representing transitions between the first AI agent and the second AI agent.

19. The method of claim 11, wherein the intermediate input includes one or more of:
a code script for execution by the second AI agent; and
a text description of a transferred task request to the second AI agent.

20. A processor-readable storage medium storing a plurality of processor-executable instructions for collaborative multi-agent implementation at a messaging platform, the instructions being executed by one or more hardware processors to perform operations comprising:
receiving, via a communication interface integrated with the messaging platform, a plurality of user conversational inputs;
initiating, by a first artificial intelligence (AI) agent from the plurality of the AI agents, a task request based on an ongoing conversation session involving one or more of the plurality of user conversational inputs;
generating, by the first AI agent, an intermediate input invoking a second AI agent from the plurality of the AI agents based on the task request;
causing a first display at a user interface on the messaging platform the intermediate input that identifies the second AI agent;
generating, by the second AI agent, an output to the task request;
causing a second display at the user interface on the messaging platform the output to the task request;
integrating a multi-agent system including at least the first AI agent and the second AI agent connected to the first AI agent into the ongoing conversation session on the messaging platform; and
continuing monitoring, by the multi-agent system, the ongoing conversation session for identifying a second task request.
